(19) United States
(12) Patent Application Publication
(10) Pub. No.: US 2026/0360232 A1
(43) Pub. Date: Nov. 12, 2026

(54) DISPLAY DEVICE AND METHOD FOR OPERATING THE DISPLAY DEVICE

(71) Applicant: Balluff GmbH, Neuhausen auf den Fildern (DE)

(72) Inventors: Martin Weller, Waiblingen (DE); Tobias Wiens, Vaihingen (DE); Viktor Virág, Hárskút (HU); Peter Tárkányi-Kovács, Zirc (HU); Kristóf Simon, Veszprém (HU); Mihály Gyurján, Újfehértó (HU)

(73) Assignee: Balluff GmbH, Neuhausen auf den Fildern (DE)

(21) Appl. No.: 19/643,247

(22) Filed: Apr. 9, 2026

(30) Foreign Application Priority Data
May 6, 2025 (DE) 102025117242.0

(51) Int. Cl. G08B 5/38; F21V 23/06; G08B 3/10; G08B 6/00; G08B 7/06; F21W 111/00; F21Y 103/10; F21Y 107/40; F21Y 115/10

(52) U.S. Cl. CPC G08B 5/38; F21V 23/06; G08B 3/10; G08B 6/00; G08B 7/06; F21W 2111/00; F21Y 2103/10; F21Y 2107/40; F21Y 2115/10

(57) ABSTRACT

A display device with a housing is described in which at least one display LED for displaying light information and at least one signalling LED provided in addition to the at least one display LED for signalling a warning state are arranged, wherein a brightness of the at least one signalling LED is greater than a brightness of the at least one display LED , wherein the at least one display LED and the at least one signalling LED can be controlled separately from each other.

### PRIOR ART

It is known from experience that a display device in the form of a stack light or an indicator, is installed on or attached to a machine or machine system in a factory hall, in order to display various states of the respective machine by means of a display field of the stack light or the indicator. While, in the case of a stack light that is axially elongated compared to the transverse extension, the display field is arranged in a central transparent housing part between a connection base of the housing and a cap of the housing, in the case of an indicator that is formed to be axially short compared to the transverse extension, the display field is arranged below a covering surface of the transparent cap of the housing of the indicator. In the case of the two display devices, the display field itself is formed by means of a plurality of display LEDs that are arranged and can be controlled in such a way that, individually or in groups, they display light information (also often colour-coded light information) in segments, said light information being able to be allocated to a state of a plurality of states to be displayed. The states can, for example, be different operating states of the machine.

DE 10 2012 023 190 B4 describes a stack light that has a rod-shaped, transparent housing, in the interior of which a rod-shaped signal transmitter with RGB LEDs is arranged. A light distribution element is arranged in the housing between the signal transmitter and the transparent housing and directs light in a plane from the RGB LEDs to the housing wall. The light distribution element is formed as a light distribution film, which is attached to the inside of the housing wall by means of a projection extending into the interior of the housing. The projection forms two opposite grooves for receiving the film ends of the light distribution film.

It is conceivable that a stack light can have an integrated signal tone generator that emits an extra-loud tone in the case of a warning state to be displayed. Here, a warning state can, for example, indicate a critical state of the machine and/or a dangerous or life-threatening situation for an operator of the machine or a worker in the factory hall.

However, such a stack light has the disadvantage that the operator of the machine or the worker in the factory hall cannot hear such a signal tone, despite its high volume, in a noisy work environment where, for example, milling or pressing is taking place. Additionally or alternatively, it may be that the operator must wear hearing protection in the noisy surroundings for occupational safety reasons, even if the noise is not actually present in the specific case, such that the signal tone can be lost. Due to the geometry of the stack light, it is also not always possible to install a signal tone generator in order to indicate a warning state. For example, the housing of the indicator can be too small in order to accommodate a signal tone generator.

### Disclosure of the invention

Thus, an object of the invention is to provide a display device that can safely, simply and cost-effectively display a warning state.

According to a first aspect of the invention, the object is solved by a display device having a housing in which at least one display LED for displaying light information and at least one signalling LED provided in addition to the at least one display LED for signalling a warning state are arranged, wherein a brightness of the at least one signalling LED is greater than a brightness of the at least one display LED, wherein the at least one display LED and the at least one signalling LED can be controlled separately from each other. Here, the at least one signalling LED can be configured to blink and/or to flash in the case of a warning state.

The display device according to the invention can thus have two separate LEDs that can have different brightness levels and can also be controlled differently and can thus fulfil different tasks. While the at least one display LED is configured to display light information that can be allocated, for example, to different operating states of a machine, the at least one signalling LED can be configured to display a warning state due to its brightness being superior to that of at least one display LED.

Providing this optical extra element can lead to no very loud audible signal from the indicator device having to be generated in the case of the warning state to be displayed, since the optical signal light - similar to a speed camera sign at a motorway construction site - increases the attention of an operator or worker and can thus have a strong signalling effect, even when no tone is to be heard. The warning state can also be perceived by an operator or worker with hearing impairments. Furthermore, the flashing and/or blinking of the signalling LED is visible even in peripheral vision, for example, such that malfunctions or critical states of machines can no longer be overlooked or ignored. Furthermore, the operator can forgo wearing hearing protection in the surroundings of the display device, as they would have to with a loud signal tone, for example.

Since no display LED is used to signal the warning state, the function of the display LED can be fully retained, even if the at least one signalling LED blinks and/or flashes. Furthermore, it is possible that the entire display device can be operated with low industrial current up to 24V direct current and does not require 230V alternating current.

Since the signalling LED can be permanently integrated into the display device, the display device can be formed to be particularly compact and thus cost-effective, despite additional necessary electronics. Compared to a warning device provided separately to the display device, unauthorised removal of the signalling LED, which would compromise the safety of the display device, can also be prevented.

In one embodiment, the display device has a plurality of display LEDs that together form a display field and are configured to display (in particular, colour-coded) light information in segments in the display field (in particular individually and/or in groups), wherein the display device additionally has the at least one signalling LED. In other words, the signalling LED can be installed separately or in a different position and perform the function of displaying the warning state, while the display field can display normal operating states of the machine.

In one embodiment, the or each signalling LED is arranged adjacent to a housing wall of the display device, and an emission surface of the or each signalling LED is directed outwards from the housing. Thus, the brightness of the signalling LED(s) can be particularly high, since any loss of brightness due to possible transport paths can be minimised.

In one embodiment, the or each signalling LED is arranged on a carrier extending (in particular substantially) in parallel to an axial axis of the housing, which can in particular be formed as a printed circuit board.

The signalling LED(s) can be arranged in particular in a (different) corner or in a (different) corner region of a cross-section through the housing, which can in particular run substantially perpendicular to the axial axis, such that light emissions can be carried out into a spatial segment.

In one embodiment, the signalling LED is arranged adjacent to a housing wall of the display device, wherein an emitting surface of the signalling LED points towards a connection socket of the housing, wherein a light coupling element (particularly in a corner region of the cross-section and/or in particular in direct contact) is arranged adjacent to the signalling LED, wherein the light coupling element is set up to deflect light emitted from the signalling LED towards the connection socket in such a way that the light can be guided out of the housing substantially in parallel to the emitting surface. For example, the light coupling element can be formed as a prism, in particular a truncated pyramid prism, which can be adhered to the signalling LED. This type of light guidance can cause a particularly simple emission direction of the generated light radially outwards, without the operator or worker being able to look unintentionally directly into the signalling LED.

In one embodiment, one signalling LED of a plurality of signalling LEDs is arranged in each corner or in each corner region of the cross-section when seen in a cross-section through the housing. Directly mounting the signalling LEDs in the corners of the housing allows for a particularly simple design of the display device. The signalling LEDs can thus be positioned closer to an output opening on the housing and to shine directly into or through a housing wall of the housing.

Here, the cross-section can run transversely, in particular perpendicularly, when seen with respect to an axial axis or direction of the housing, such that the light emission from the housing can be carried out at the same height and thus can be equally visible from all sides.

If the display device has light coupling elements, each light coupling element can be arranged in a corner region (and in particular in direct contact) adjacent to the respective signalling LED, wherein each light coupling element is set up to deflect light emitted from the respective signalling LED towards the connection socket in such a way that the light can be directed out of the housing substantially in parallel to the emitting surface. The light coupling elements can each be formed as a prism.

There can be so many signalling LEDs provided as the cross-section can have corners. In particular, the cross-section can have three corners and three signalling LEDs can be provided.

The signalling LEDs can be arranged on a common carrier (in particular in the case of a design with light coupling elements), in particular a printed circuit board. It is also possible (in particular in the case of a design without light coupling elements) for each signalling LED to be arranged on its own separate carrier, in particular a printed circuit board. The signalling LEDs can be arranged in particular on a different carrier, in particular a printed circuit board, from the display LEDs, said carrier (in particular in the case of a design with light coupling elements) running perpendicularly to or (in particular in the case of a design without light coupling elements) in parallel to the carrier of the display LEDs.

In an alternative embodiment, first light guides of the display device run from a common centre point inside the housing to the outside, wherein in each case a signalling LED of a plurality of signalling LEDs for signalling the warning state is arranged adjacent to the centre point between any two adjacent first light guides of the first light guides. This indirect arrangement of the signalling LEDs inside (especially in the centre of) the housing allows for a particularly compact design of the display device, while the generated light can be efficiently and reliably guided out of the housing via light guides. Furthermore, emission in different directions, in particular around the entire housing, can be possible.

In one embodiment, the first light guides run radially outwards radiantly from a common centre point in a cross-section through the housing. Thus, the display device can be formed in a particularly efficient and cost-effective manner, since the light has to travel short paths from the interior to the exterior.

Here, the cross-section can run transversely, in particular perpendicularly, when regarded with respect to the axial axis or direction of the housing, such that the light emission from the housing can be carried out at the same height and thus can be equally visible from all sides.

In one embodiment, the emitting surface of the respective signalling LED points in the direction of the common centre point of the first light guides, such that light emitted by the signalling LEDs can be guided out of the housing via the centre point in the first light guides. This indirect emission of the signalling LED into the interior of the housing can prevent a direct view of the emitting surface, such that eye damage to the operator who might unintentionally look at an emitting surface facing them can be avoided.

In one embodiment, a second light guide (in particular in direct contact) is respectively arranged between each signalling LED and the centre point of the first light guide, such that particularly good light coupling of the signalling LEDs into the common centre point of the light guides is enabled.

The two light guides can also be arranged in the cross-section.

The first and/or the second light guides can be connected via the common centre point, i.e. can be formed as a single piece. Thus, the display device can be manufactured cost-effectively with few components, which can also be prefabricated and installed in the display device.

The first light guides can end in corners of the cross-section through the housing.

There can be as many first light guides, second light guides and signalling LEDs provided as the cross-section can have corners.

In the case of a triangular cross-section, exactly three first light guides and exactly three second light guides, and three signalling LEDs can be provided. Each of the first light guides or each of the second light guides can then be respectively spaced 120 degrees away from the other adjacent first light guides or the other adjacent second light guides. The first light guides can be rotated by 60 degrees relative to the second light guides around a common centre point, which can be lie, in particular, on an axial axis of the housing.

In this construction, the signalling LEDs can be mounted on a common carrier, for example a common printed circuit board, with the display LEDs. It is also possible for the signalling LED and the display LED to be arranged on a separate carrier, in particular printed circuit board.

In one embodiment, the housing has a recess in the region of the light output of the light emitted by the signalling LEDs into the surroundings, such that the light can also be able to be directed into the surroundings even if the housing material is not transparent. Here, the recess can be larger than the actual light-emitting surface, such that scattered light can also be used to signal the warning state. Furthermore, a transparent element (in particular a precisely fitting one) can be inserted into the recess, which can act as a window and prevent contamination of the interior of the housing.

The housing can be formed of multiple parts. A region of the housing in which display LEDs and/or the signalling LEDs can be arranged can be formed to be transparent or opaque. The housing can be manufactured cost-effectively from plastic.

In one embodiment, the display device further has a light distribution element that is arranged adjacent to the housing wall and set up to distribute light that can be generated by the or each display LED and/or the or each signalling LED in the direction of the housing wall. Here, the light distribution element can extend only in the region of the display LED(s), such that a brightness of the signalling LEDs cannot be diminished for the operator. Alternatively, the light distribution element can extend adjacently to the display LED(s) and the signalling LED(s), such that the emitted light from both LED(s) can be directed outwards. Alternatively, the light distribution element can here extend only adjacently to the signalling LED(s), such that the worker can look directly into the light from the signalling LEDs without risk of injury. The light distribution element can cover the housing inner wall and/or be attached to the housing inner wall. Providing the light distributing element can make it possible for an observer to be able to look directly into the light from the display device without having to fear impairing their eyesight. The light distributing element can, for example, be a transparent inner wall with regularly arranged round holes.

The light distribution element can also substantially follow a shape of the housing wall.

In one embodiment, the light distribution element is formed as a light distribution film which is set up to guide light generated by the indicator LED(s) and/or signalling LEDs in a plane-like manner (in particular, substantially perpendicular to the axial axis of the housing wall). The light distribution film can, for example, have microlenses of many various shapes and/or additive light-scattering bodies, with which the light path of individual light rays can be able to be changed. Thus, the emitted light from an LED can be perceived as a broadened spot of light, such that the worker can look directly into the LED light. The film can be applied directly to the inside of the housing wall.

In one embodiment, the display device is formed as a (particularly axially long) stack light, wherein the at least one signalling LED, in particular all signalling LEDs, is arranged under a cap of the housing of the stack light in an assembled state, said cap being lying opposite a connection socket of the stack light, wherein the at least one display LED, in particular all display LEDs, are arranged between the connection socket and the cap (in particularly within a transparent central part of the housing). Thus, with the stack light, the axial extent can be greater than its transverse extension, which runs perpendicularly to an axial axis of the stack light. In other words, the stack light can be formed to be rod-shaped. With this type of display device, the signalling LED can be installed either indirectly in the centre of the cap or directly in the corner regions of the cap.

A first carrier, in particular a printed circuit board, for the display LED(s) can run substantially in parallel to the axial axis of the stack light. The first carrier can have a polygonal cross-section, for example, triangular or quadrilateral, and one or more display LEDs can be mounted on each of the multiple side walls of the first carrier in the direction of the housing side wall. Instead of a single-piece first carrier, the first support can also be formed of multiple parts. A second carrier, in particular a printed circuit board, can, for example, run substantially perpendicularly to the first carrier. One or more end regions of the first carrier can, for example, extend through one or more corresponding recesses of the second carrier and be arranged to be fixed in position by means of one or more fastening elements. The fastening elements can be attached to the side of the second carrier pointing to the connection socket. Such fastening elements can, for example, be contact springs that can be attached to the second carrier, for example, screwed in place, and can clamp the first carrier for the display LED(s) in a fixed position. Furthermore, a different third carrier, in particular a printed circuit board, can be provided for each signalling LED, which can also extend substantially in parallel to the axial axis and on which the respective signalling LED can be mounted. These third carriers can each extend through a corresponding (in particular, one-sided open) recess in the second carrier and be held in a fixed position relative to the second carrier, for example by soldering.

The or each signalling LED can, for example, be arranged on one side of the second carrier that points to the display LED(s), such that a compact design of the display device can be achieved.

In a stack light with a substantially triangular cross-section, the three signalling LEDs can each be arranged offset by 60 degrees from the three groups of display LEDs when viewed from above, which in turn can each be arranged offset by 90 degrees from one another.

The emitting surface of the or each signalling LED can be substantially parallel to the axial axis of the stack light. This measure can be implemented in particular when the stack light cannot have a light coupling element or a light guide, and the signalling LED(s) can be arranged adjacent to the housing wall. An emitting surface of the or each display LED can also be substantially parallel to the axial axis of the stack light.

The housing wall towards which the emitting surface of each signalling LED points can be a side wall of the central part of the housing. This housing part can, for example, be transparent.

In one embodiment, the recess is arranged in the region of a part of an edge of the cap (particularly an axial one) and opens towards the connection socket. In other words, the cap can thus be cut away towards the connection socket and, viewed in cross-section, reach around the housing edge. It is understood that the edge itself can be "shortened" due to the recess. The recess can also be formed to be symmetrical with respect to the edge, such that the emitted light can be clearly visible from two sides.

A plurality of recesses can be provided in the cap, each provided at the (in particular axially extending) edges of the cap.

In one embodiment, the recess is arranged in the region of a part of an edge (in particular an axial one) of the cap on the side of the cap facing away from the connection socket. Here, the recess can optionally reach into a top surface of the cap. The recess can be completely enclosed by the cap and form an opening. In other words, a window can be provided in the corner region of the cap, i.e. in the corner and partially along the edge, in the region where the light exits the cap. It is understood that the edge itself can be "shortened" due to the recess. The recess can also be formed to be symmetrical with respect to the edge, such that the emitted light can be clearly visible from two sides.

A plurality of such recesses can be provided in the cap, each provided at the (particularly axially running) edges of the cap and optionally reach into the covering surface.

In the two embodiments of the recess, such a recess can be provided per signalling LED in order to allow light to escape from the housing.

In one embodiment, the display device is formed as an indicator (particularly an axially short one), wherein the at least one signalling LED, in particular all signalling LEDs, are arranged in a connection socket of the indicator in an assembled state, which is opposite a cap, and wherein the at least one display LED, in particular all display LEDs, is arranged in the cap (which is translucent and optionally opaque, in particular in the region of the display field). The axial extension of the indicator can be less than the transverse extension of the indicator, which runs perpendicularly to the axial axis A. In particular, the housing can be formed in two parts with only a cap and a connection socket. In particular, the connection socket can be provided with a threaded base, which can be arranged on a side of the connection socket facing away from the cap. With this type of display device, both indirect installation of the signalling LED in the middle of the connection socket and direct installation of the signalling LEDs adjacent to the housing wall (in particular in the corners) of the connection socket can be achieved.

In the case of the indicator, the display LED(s) can be arranged on a first carrier, in particular a printed circuit board, which can run substantially perpendicularly to the axial axis of the indicator. Each signalling LED(s) can be arranged on a separate second carrier, for example a printed circuit board, which can run substantially in parallel to the axial axis of the indicator. These second carriers can each extend through a corresponding (in particular, one-sided open) recess of the first carrier for the display LEDs and be held in a positionally fixed position relative to the first carrier, for example by means of soldering. The or each signalling LED(s) can, for example, be arranged on a side of the first carrier facing the connection socket, such that a compact construction of the display device can be achieved.

Alternatively, the display LED(s) of the indicator can be arranged on the same carrier as the signalling LED(s). This carrier can run substantially perpendicularly to the axial axis of the indicator. For example, the signalling LED(s) can be arranged on a side of their carrier on which the display LED(s) can be arranged, or they can be arranged on a different side of the carrier as the display LED(s).

In both arrangements of the signalling LED(s) and display LED(s) on the carrier of the indicator, the housing wall towards which the radiating surface of each signalling LED can point can be a side wall of the connection socket of the housing, which can run, in particular, substantially in parallel to the axial axis of the indicator. In other words, a radiating surface of the signalling LED(s) can be substantially parallel to the axial axis of the indicator. A radiating surface of the display LED(s) can point towards a covering surface of the cap, i.e. run substantially perpendicularly to the axial axis of the indicator.

In one embodiment, the recess is arranged as an (in particular round or square) opening in the region of a part of the (in particular axially running) edge of the connection socket. Such a recess can be provided for each signalling LED in order to allow light to exit the housing. It is understood that the part of the edge can be "missing" due to the recess. The recess can also be formed symmetrically with respect to the edge, such that the emitted light can be clearly visible from two sides.

In particular, the indicator can be formed without a light distribution element adjacent to a covering surface of the cap, through which the emitted light from the display LED(s) can escape. In this case, the cap can be formed opaquely, such that the light from the display LEDs can be attenuated. It is also possible that the indicator has the light distribution element, in particular the light distribution film, in the region of the emitted light from the display LEDs.

In particular, the indicator can be formed without a light distribution element, which can be arranged adjacent to the housing wall and set up to distribute light that can be generated by the signalling LED(s) in the direction of the housing wall. Here, the housing wall can be a side wall of the connection socket.

It is also possible that the indicator can have a light distribution element which is arranged adjacent to the housing wall and set up to distribute light that can be generated by the signalling LED(s) in the direction of the housing wall. Here, the housing wall can be a side wall of the connection socket. The light distribution element can cover the inner housing wall and/or be attached to the inner housing wall. Providing the light distribution element can allow an observer to be able to look directly into the light of the indicator without them having to fear damaging their eyesight. The light distribution element can, for example, be a transparent wall with regularly arranged round holes.

The light distribution element can also substantially follow a shape of the housing wall.

The light distribution element of the indicator can also be formed as a light distribution film, which is set up to direct the light that can be generated by the signalling LED(s) in a plane substantially perpendicular to the axial axis towards the housing wall. The light distribution film can, for example, have microlenses of various shapes and/or additive light scattering bodies, with which the light path of individual light rays can be able to be changed. Thus, the emitted light from an LED can be perceived as a broadened spot of light, such that the worker can also look directly into the LED light. The film can be applied directly to the inside of the housing wall.

In one embodiment, a brightness of at least one signalling LED or of each signalling LED can correspond to a risk group (RG) RG0, which can be set in the standard DIN EN 62471, photobiological safety of lamps and lamp systems. It is also possible for the brightness of the signalling LED(s) to be able to be limited to a maximum level according to RG01. It is also possible that the brightness of the signalling LED(s) can be set according to a higher RG and correspondingly reduced by means of a circuit to a brightness according to a lower RG (e.g. RG0). In this way, a certain brightness level of the display device is not exceeded, such that no further regulatory-related shielding measures need to be taken.

In one embodiment, the at least one signalling LED or all signalling LEDs have a fixed colour that is neither adjustable nor reconfigurable. This colour can be a discrete colour (for example, white or blue). It is also possible for the fixed colour to correspond to a colour combination that can be formed from several discrete colours (for example, red, green, and blue). In this case, several corresponding signalling LEDs are present, which can be arranged adjacent to each other in order to be able to achieve the desired colour effect.

Additionally or alternatively, the at least one display LED or all display LEDs in one embodiment is an RGB LED, and a colour of the at least one display LED or of each of the display LED can be adjustable. Furthermore, the illumination duration, brightness, and illumination duration of the display LED(s) can be adjustable. A brightness of the display LED(s) can be set according to RG0.

In one embodiment, a brightness of the at least one signalling LED or of each of the signalling LEDs, measured in lumens, is at least twice, preferably at least three times, further preferably at least four times, further preferably at least ten times, as high as a brightness of the at least one display LED or of each of the display LEDs, such that the associated flashing light can be clearly distinguished from the light of the display LEDs.

In one embodiment, a light flux of a display LED can be between about 1 lumen and about 12 lumens, preferably between about 1.5 lumens and about 11 lumens, further preferably between about 1.6 lumens and about 10 lumens.

In one embodiment, the light flux of a signalling LED can be between about 130 lumens and about 160 lumens, preferably between about 140 and about 150 lumens, further preferably between about 145 lumens and about 147 lumens.

For example, a red display LED can have a light flux of approximately 3.5 lumens, a green display LED can have a light flux of approximately 10 lumens, a blue display LED can have a light flux of approximately 1.6 lumens, and/or a white display LED can have a light flux of approximately 6 lumens. The light flux of a signalling LED or each signalling LED, can be approximately 146 lumens.

Additionally or alternatively, a performance class of the signalling LED or each signalling LED and/or a display LED or each display LED can be approximately 0.5 watts (manufacturer's designation Mid) or 1 watt (manufacturer's designation High).

In an embodiment, the emitting surface of the at least one signalling LED or the signalling LEDs is at least twice, preferably at least three times, further preferably at least four times as large as the emitting surface of the at least one display LED or the display LEDs.

A cross-section of the housing can be formed to be polygonal, in particular square or triangular, each with rounded or outwardly curved edges.

According to a second aspect of the invention, a system is provided having a display device according to the first aspect, having a wirelessly connectable control device, and having a portable wireless terminal device that is set up to emit a warning message synchronised with a flashing and/or blinking of the at least one signalling LED.

The use of wireless communication between the control device, display device, and terminal device can cause reliable signalling of the warning state without impeding the environment or other people. Since a display device can generally be mounted high on a machine, the display device can optionally be controllable wirelessly. The operator or worker can also be warned by the terminal device even when the display device is not within their field of vision and/or they have optionally moved further away from the display device. If the operator or worker does have the display device in view, the warning effect can be additionally increased by the terminal device.

The terminal device can be portable, for example as a button in the ear or on clothing.

Wireless communication can be carried out via WiFi, IO-Link Wireless and/or Bluetooth, or via a different wireless technology. For example, in the case of WiFi, the control device can, for example, be a router or edge gateway of a private network which acts as a range extender.

In one embodiment, the warning message is formed to be visual (for example a flash of light or a blinking of a light), haptic (as a vibration) and/or acoustic (as a sound or vibration noise).

According to a third aspect of the invention, a method for operating the display device is provided, which has a housing in which at least one display LED for displaying light information and at least one signalling LED, provided in addition to the at least one display LED, for signalling a warning state are arranged, having the steps of displaying light information by means of the at least one display LED, and signalling a warning condition by means of flashing and/or blinking of the at least one signalling LED, wherein a brightness of the at least one signalling LED is greater than a brightness of the at least one display LED, wherein the at least one display LED and the at least one signalling LED are controlled separately from each other.

The control can be carried out by means of wireless technology (for example WiFi, IO-link wireless and/or Bluetooth) and/or by means of IO-link.

In one embodiment, the method further includes time-synchronised emission of a warning message by means of a portable wireless terminal device and signalling the warning state by means of flashing and/or blinking of the at least one signalling LED.

### BRIEF DESCRIPTION OF THE DRAWINGS

Exemplary embodiments of the invention are depicted in the drawings and explained in more detail in the following description. Here are shown:

FIG. 1 shows a display device according to a first exemplary embodiment in the form of aa stack light in a perspective explosion view;

FIG. 2 shows an end region of the stack light in FIG. 1 in a perspective view;

FIG. 3 shows a cross-section of the stack light in FIG. 2;

FIG. 4 shows the stack light in FIG. 1 in a schematic perspective explosion view;

FIG. 5 shows a cross-section of the stack light in FIG. 1 in a top view;

FIG. 6 shows an end region of a display device according to a second exemplary embodiment in the form of a stack light in a perspective view;

FIG. 7 shows a schematic view of the stack light in FIG. 6 in an exploded view;

FIG. 8 shows a cut-out of the stack light in FIG. 7 in the region of the cap in a perspective view;

FIG. 9 shows a cut through the stack light along a line A-A in FIG. 7;

FIG. 10 shows a detailed view from FIG. 8 in cross-section;

FIG. 11 shows a display device according to a third exemplary embodiment in the form of a stack light in a schematic view from below;

FIGS. 12 and 13 shows an electronic system of the display device in FIG. 11;

FIG. 14 shows the display device in FIGS. 11 to 13 in two operating modes in the perspective view and in a top view;

FIG. 15 shows a display device according to a fourth exemplary embodiment in the form of an indicator;

FIG. 16 shows a top view of the display device in FIG. 15 in a schematic view;

FIG. 17 shows a system having the display device in FIG. 1, a control device and a portable wireless terminal device.

FIG. 18 shows a method according to an exemplary embodiment, which runs in an operation of the display device in FIGS. 1 to 17.

### EMBODIMENTS OF THE INVENTION

The same or similar components or elements are provided with the same reference numerals.

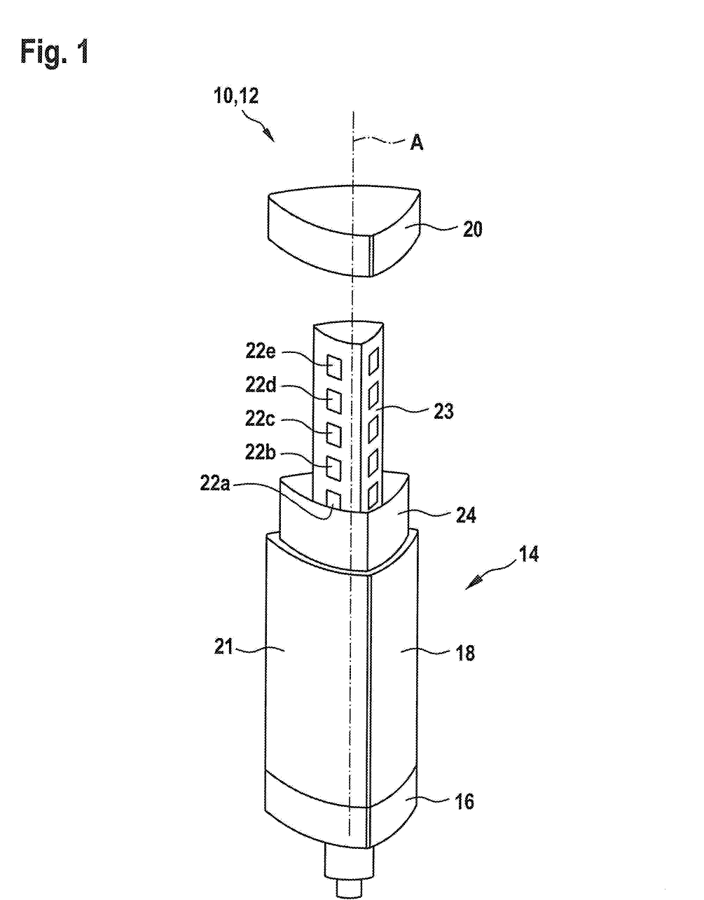

A display device labelled with the reference numeral 10 in FIG. 1 is formed in the form of a stack light 12. It has a three-part, rod-shaped housing 14, which has an opaque connection socket 16, a transparent, rod-shaped central housing 18, and an opaque cap 20. The housing 14 is formed to be long along an axial axis A and has a substantially triangular cross-section perpendicular to the axial axis A or direction, with outwardly curved sides. The connection socket 16 and the cap 20 are provided at opposite ends of the stack light 12. In the connection socket 16, there are connections and the associated electronic system for controlling the stack light 12. Here, one of these connections serves for wireless communication by means of WiFi. Furthermore, one connection of the connections is provided for communication by means of IO-Link. Within the transparent central housing 18, a plurality of display LEDs are arranged which extend in three groups in the axial direction in parallel to one of the three housing walls 21 of the transparent central housing 18 in each case. The depicted display LEDs of the three groups are labelled with 22a-22e. The display LEDs 22a-22e of a group are mounted on a corresponding carrier 23 in the form of a printed circuit board and form a display field and are set up to display colour-coded light information segment-by-segment in the display field, depending on the operating state of a machine on which the stack light is mounted. The three display fields can be controllable to display the identical light information in a time-synchronised manner, here simultaneously. All display LEDs 22a-22e are formed as RGB LEDs and set up to emit light with a brightness according to RG0. A colour, illumination duration, brightness, and illumination time of the display LEDs 22a-22e are adjustable here. Instead of a single-piece carrier 23 with a triangular cross-section, on whose three outer sides in each case one of the three groups of the display LEDs 22 are arranged, three separate carriers can also be provided, on which in each case a group of the display LEDs 22 is arranged.

The stack light 12 further has a light distribution element 24, which is formed as a light distribution film. The film 24 is set up to guide the light that can be generated by the display LEDs 22a-22e outwardly in planes perpendicular to the axial axis A. The film 24 extends in direct contact over the entire length of the central housing 18 to its end under the cap 20 and is fixed to the housing wall 21 adjacent to it.

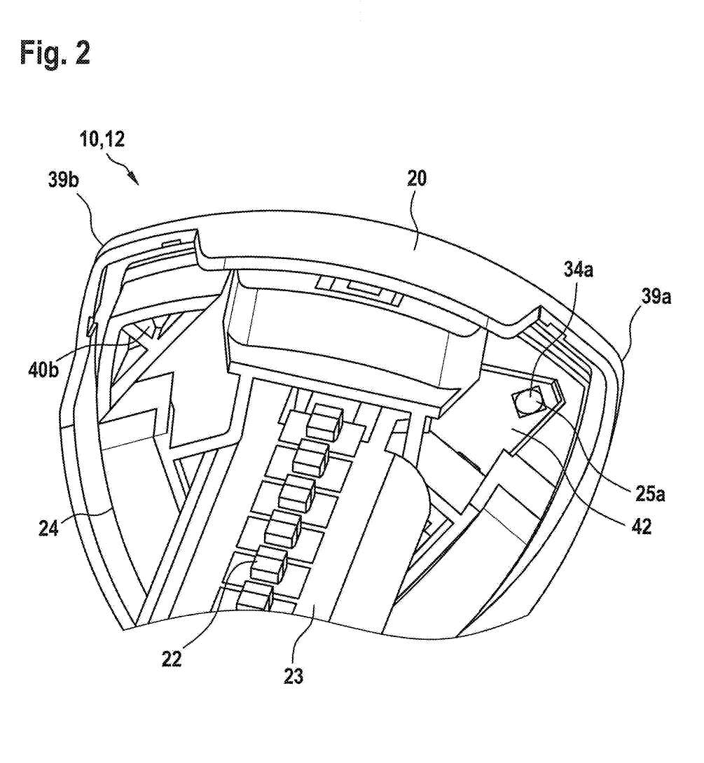

As shown in FIGS. 2-5, the stack light 12 additionally has three signalling LEDs 25a-25c, which are set up to signal a warning state by means of flashing and/or blinking. The display LEDs 22a-22e and the signalling LEDs 25a-25c can be controlled separately from one another. In the case of a warning state, the signalling LEDs 25a-25c can be controlled in such a way that they flash and/or blink, while the display LEDs 22a-22d simultaneously show an operating state of the machine. A brightness of the signalling LEDs 25a-25c is ten times as bright as a brightness of the display LEDs 22a-22e. A colour of the signalling LEDs 25a-25c is not adjustable and corresponds to a discrete colour (white or blue) or a colour combination of discrete colours (for example, red, green, and blue). In the case of a colour combination, instead of only one signalling LED 25a-25c, several signalling LEDs are provided adjacent to each other in the respective corners of the housing 14. As described above, the light distribution film 24 is arranged in such a way that it changes the emission of light from the signalling LEDs 25a-25c.

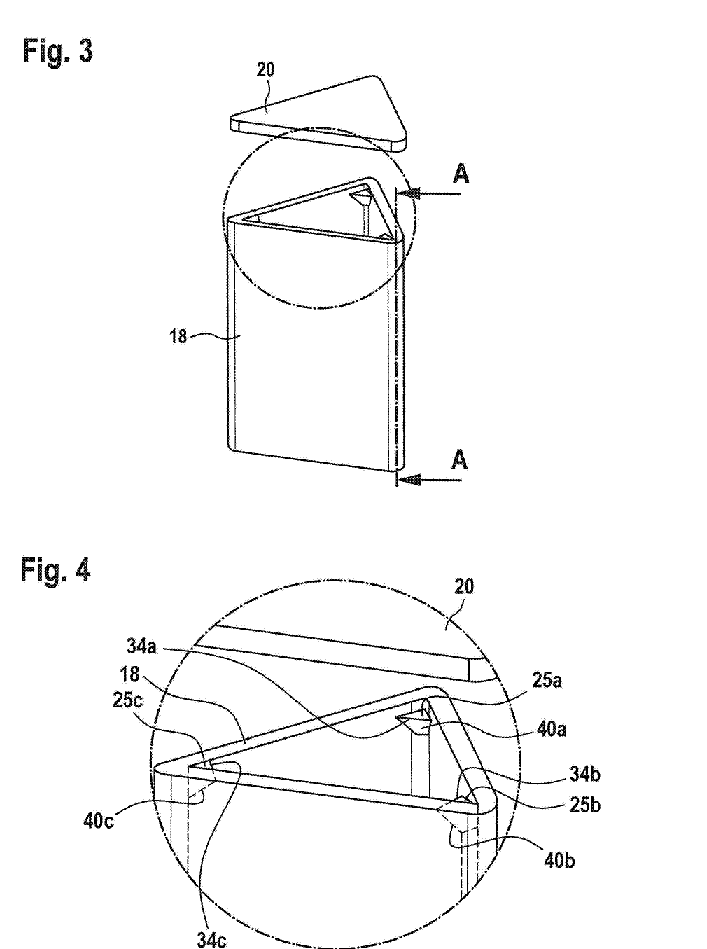

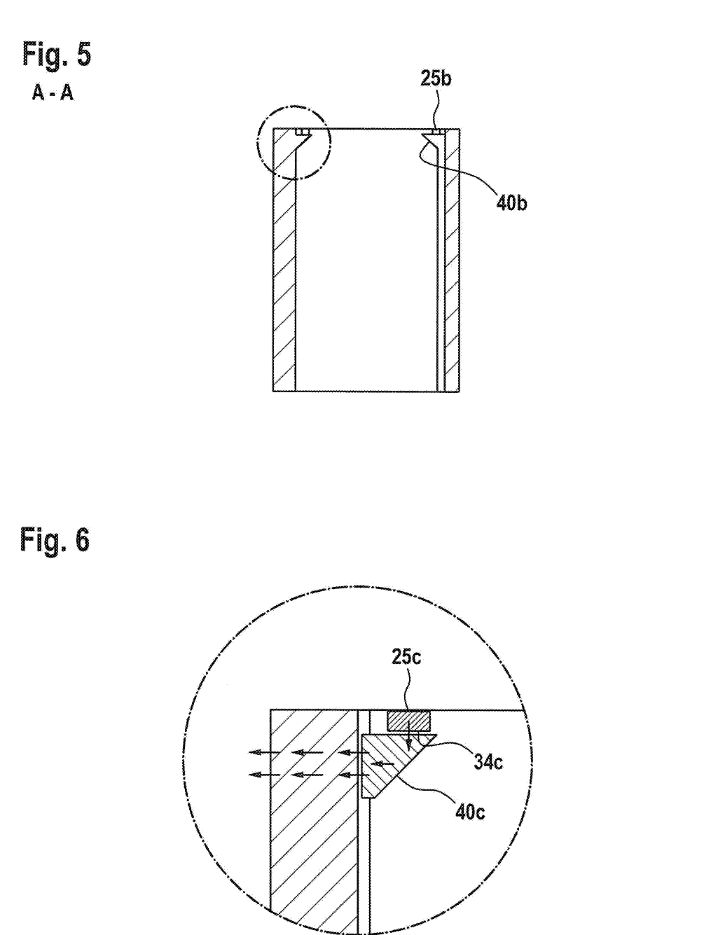

As shown in FIGS. 4 and 5, three first light guides 26a-26c are arranged under the cap 20 in the assembled state of the stack light 12, which extend radially outwards from a common centre point 28 in a cross-section through the housing 14 in the direction of corners 30a-30c of the cross-section and thus of the central housing 18 and the cap 20. Three second light guides 32a-32c are rotated by 60 degrees relative to the first light guides 26a-26c and are arranged directly at the centre point 28. The first light guides 26a-26c and the second light guides 32a-32c are formed integrally. The signalling LEDs 25a-25c are in direct contact with the free ends of the second light guides 32a-32c. A emission surface 34a-34c of the respective signalling LED 25a-25c points in the direction of the ends of the second light guides 32a-32c towards the centre point 28. Light emitted by the signalling LEDs 25a-25c can be guided via the second light guides 32a-32c to the centre point 28 and further along the first light guides 26a-26c to the corners 30a-30c. Recesses 38a-38c, which are provided in the cap 20 in the region around a part of axially running edges 39a-39c (FIGS. 2, 3), allow the light from the first light guides 26a-26c to be able to exit via the recesses 38a-38c. The recesses 38a-38c are shaped in such a way that the cap 20 is cut in the direction of the connection socket 16 and has a U-shaped profile that is symmetrical with respect to the edges 39a-39c. In other words, the part of the edges 39a-39c is missing due to the recess 38a-38c.

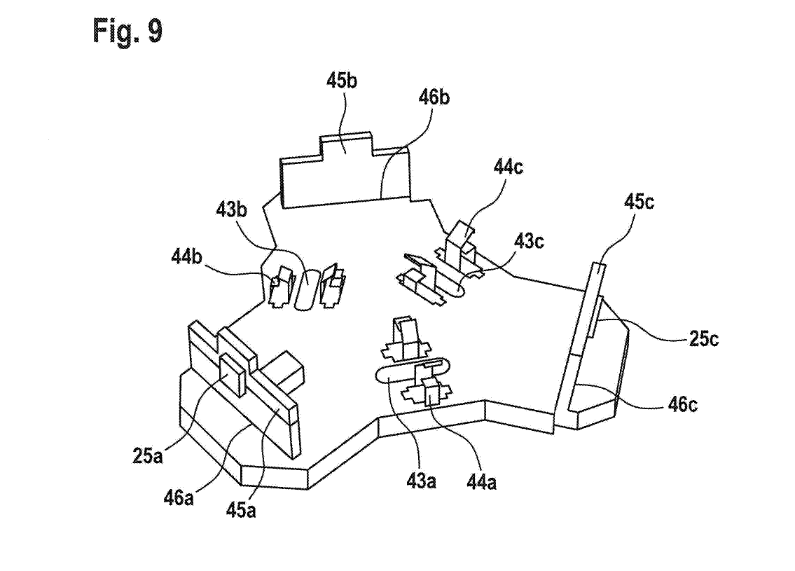

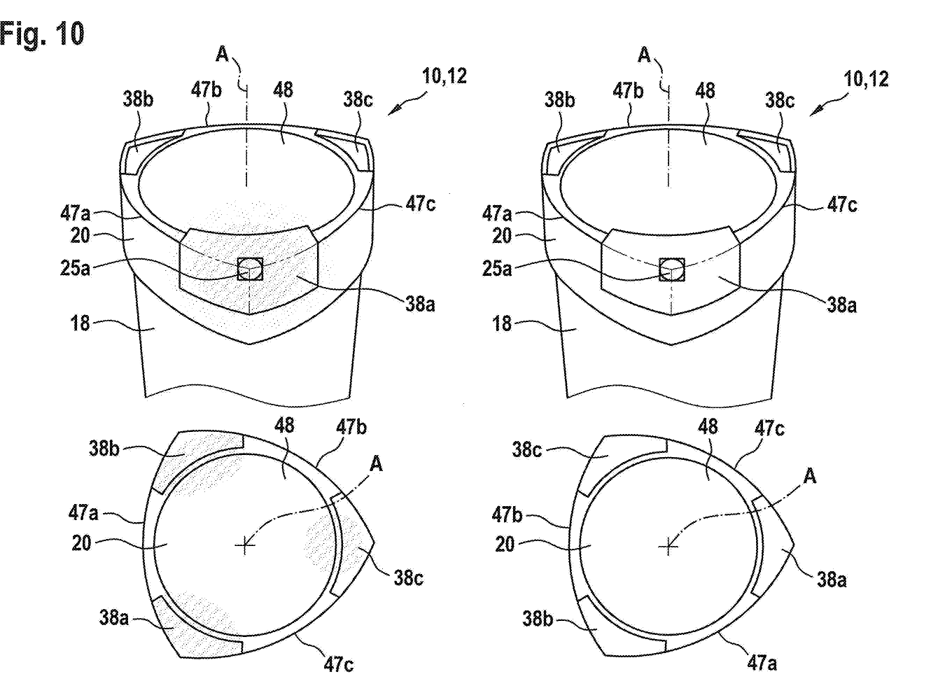

The display device 10 shown in FIG. 6 according to a second exemplary embodiment is formed similarly to the display device 10 in FIG. 1 as a stack light 12. However, the stack light 12 does not have first and second light guides 26a-26c, 32a-32c. Furthermore, the signalling LEDs 25a-25c are arranged in corners 30a-30c of the triangular cross-section through the housing 14 adjacent to the housing wall 21 under the cap 20. Fractional pyramid-shaped light coupling elements 40a-40c are also arranged in the corners 30a-30c. The signalling LEDs 25a-25c are mounted on a common triangular flexible printed circuit board 42, which is attached to the end of the carrier 23 of the display LEDs 22a-22g and perpendicular to them, for example by means of contact springs (FIG. 6). Here, the signalling LEDs 25a-25c are in corner regions of the printed circuit board 42 adjacent to the corners 30a-30c. An emission surface 34a-34c of the signalling LEDs 25a-25c points in the direction of the connection socket 16, such that light that can be emitted by the signalling LEDs 25a-25c can be guided outwardly via the light coupling elements 40a-40c substantially in parallel to the emission surface 36a-36c (FIG. 9 and 10). The light distribution film 24 is arranged adjacent to the signalling LEDs 25a-25c when seen in the axial direction, as in FIGS. 1-6, and the light distribution film 24 extends over the entire axial length of the housing wall 21 of the central housing 18.

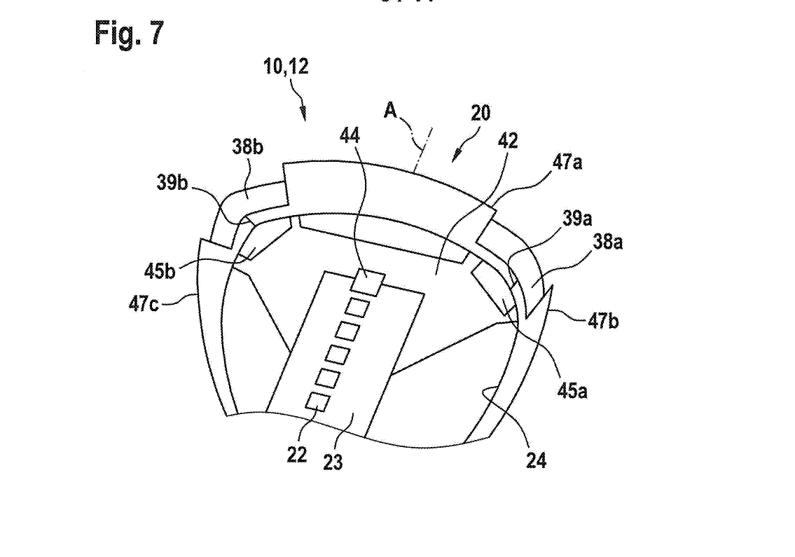

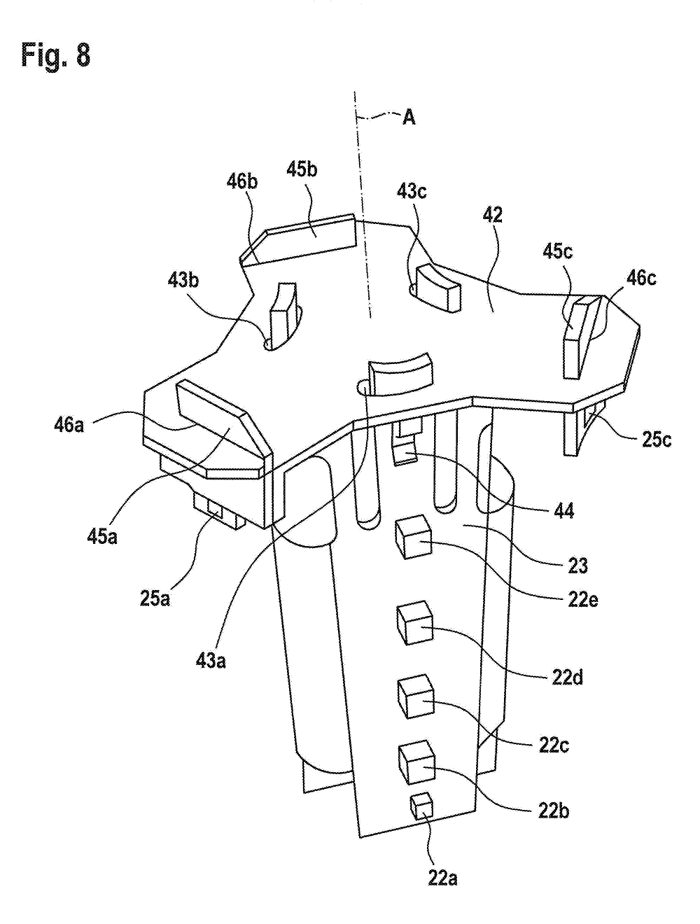

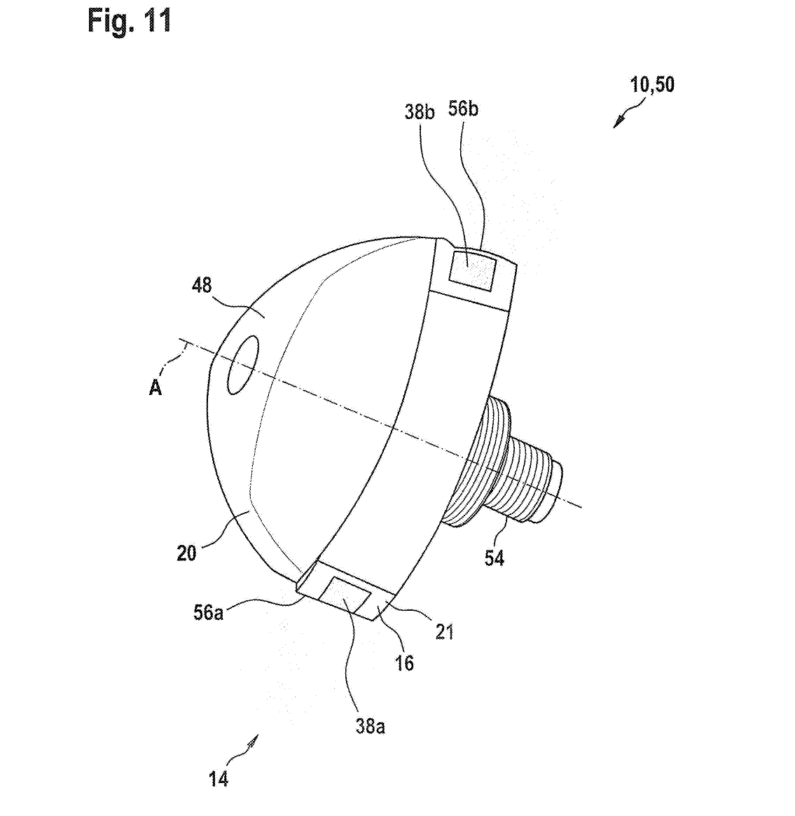

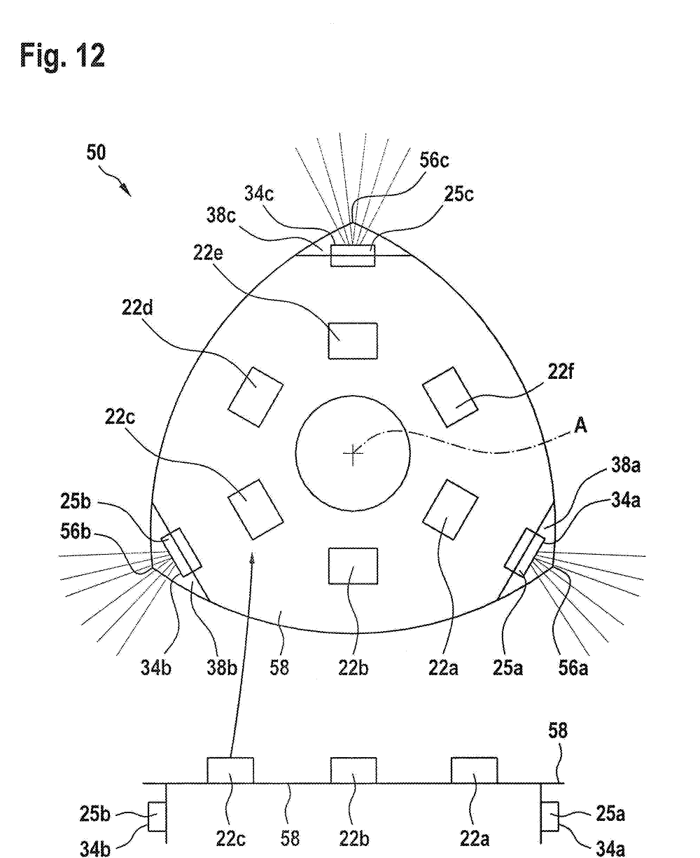

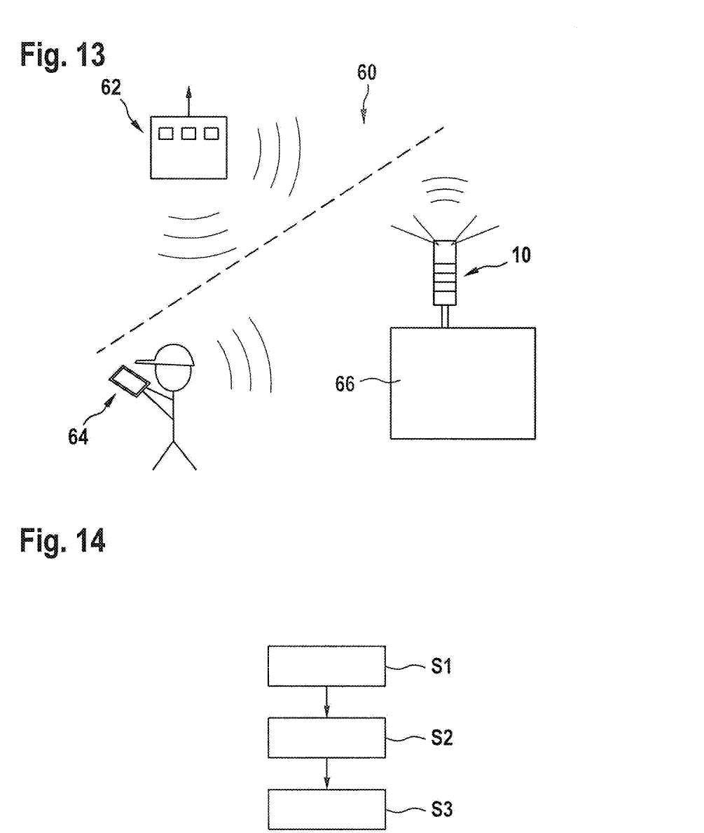

The display device 10 shown in FIGS. 11-14 according to a third exemplary embodiment is formed similarly to the display device in FIGS. 6-10. However, the stack light 12, as shown in FIGS. 12 and 13, has a second carrier 42 that extends substantially perpendicularly to the carrier 23. Here, three end regions of the carrier 23 extend through one of three recesses 43a-43c of the second carrier 42 respectively and are clamped in a positionally fixed position relative to the second carrier 42 by means of contact springs 44a, 44b which are attached to the second carrier 42 (FIG. 12). Three third supports 45a-45c, which extend in the corner regions of the housing 14 substantially in parallel to the axial axis A through one of three corresponding further one-sided open receivers 46a-46c in the second carrier 42, are soldered in a positionally fixed manner, substantially perpendicular to the second carrier 42 and relative to the second carrier 42 towards the housing side wall 21 and the connection socket 16 (FIG. 13). A signalling LED 25a-25c is mounted on each of the other third carriers 45a-45c adjacent to the housing wall 21 and pointing towards the connection socket 16. An emission surface 34a, 34c of the signalling LEDs 25a-25c here runs outwardly from the housing part 18 substantially in parallel to the axial axis A. The first carrier 23, the second carrier 42, and the third carriers 45a-45c are formed as printed circuit boards.

Furthermore, the three recesses 38a-38c are arranged in the region of the corners 30a-30c of the cap 20 and partially along the axial edges and the edges running perpendicularly to the axial axis A 39a-39c or 47a-47c of the cap 20 on the side facing away from the connection socket 16, and are additionally introduced into a cover surface 48 of the cap 20. Thus, the recesses 38a-38c form windows or openings and are completely delimited by the cap 20. The light distribution film 24 is arranged adjacent to the signalling LEDs 25a-25c, as in FIGS. 1-10, when seen in the axial direction, and extends along the entire axial length of the housing wall 21 of the central housing 18.

The stack light 14 is shown in an upper half of FIG. 14 in a perspective view in a warning state (left) and in a non-warning state (right). In a lower half of FIG. 14, the stack light 12 is shown in a top view of the cap 20 in the warning state (left) and in the non-warning state (right).

A display device 10 shown in FIGS. 15 and 16 according to a fourth exemplary embodiment is formed as an axially short indicator 50 seen along the axial axis A. In other words, the axial extension of the indicator 50 is smaller than the transverse extension of the indicator 50, which runs perpendicularly to the axial axis A. The indicator 50 has a non-transparent connection socket 16, a translucent, opaque cap 20, and a threaded base 54, which is fixed to a side of the connection socket 16 facing away from the cap 20. Three signalling LEDs 25a-25c are provided in corners of the connection socket 16 in a cross-section of the housing 14 that runs perpendicularly to the axial axis A. Here, the cross-section is substantially triangular with outwardly curved sides. Six display LEDs 22a-22f form 20 segments of the display field in the cap around a central point which lies on the axial axis A in the cross-section. Three rectangular recesses 38a-38c form openings in the connection socket 16 along its axially running edges 56a-56c. Transparent window elements can optionally be received in the recesses in a precisely fitting manner. The display LEDs 22a-22f and the signalling LEDs 25a-25c are arranged on a common carrier 58 in the form of a flexible printed circuit board. Here, the signalling LEDs 25a-25c are mounted on a side of the printed circuit board 58 pointing away from the cap 20 and thus on a different side to the display LEDs 22a-22f. An emission surface of the signalling LEDs 25a-25c points outwardly towards the side housing wall 21 and out of the housing 14, while an emission surface of the display LEDs 22a-22f points in the direction of the covering surface 45 of the cap 20. Alternatively, the signalling LEDs 25a-25c – similar to in FIG. 13 – can be mounted on separate carriers which are formed as printed circuit boards, which extend substantially in parallel to the axial axis A and perpendicularly to a carrier 58 formed as a printed circuit board for the display LEDs 22.

The signalling LEDs 25a-25c and the display LEDs 22a-22f are LEDs of the RG0 class. The signalling LEDs 25a-25c have a fixed, i.e. non-adjustable colour, which is either discrete (white or blue) or corresponds to a colour combination of discrete colours (for example, red, green, and blue) that can be able to be generated by several signalling LEDs 25a-25c adjacent to one another. The display LEDs 22a-22f are RGB LEDs with an adjustable colour. The brightness of each of the signalling LEDs 25a-25c is ten times greater than the brightness of each of the display LEDs 22a-22f. The indicator 50 has neither a light distribution film on the inside of the covering surface of the cap 20 nor a light distribution film on the inside of the side housing wall 21 in the region of the emitting surface 34a-34c of the signalling LEDs 25a-25c.

In a system 60 shown in FIG. 17 according to an exemplary embodiment, a display device 10 according to one of the previously described exemplary embodiments, shown here as a stack light 12, is provided. The system 60 further has a control device 62, which is set up to communicate wirelessly via WiFi with the display device 10 and a portable wireless terminal device 64. The terminal device 64 can be worn by an operator of the display device 10 or the machine 66, or a worker. It is set up to transmit a warning message, time-synchronised, simultaneously with a flashing and/or blinking of the signalling LEDs 25a-25c of the display device 10. The warning message can be visual, haptic and/or acoustic.

As shown in FIG. 18, in an operation of the display device 10, the display LEDs 22a-22f are controlled by the control device 62 in a step S1 and thereby supplied with a voltage in such a way that they can emit light information in different or the same colours segment by segment. Here, a segment can be formed by a display LED 22a-22f or by several display LEDs 22a-22f. In the case of a warning state, the signalling LEDs 25a-25c are separately controlled by the control device in a step S2 and thereby supplied with a voltage in such a way that the signalling LEDs 25a-25c blink and/or flash – in addition to the emission of the display LEDs 22a-22f, or also without the display LEDs 22a-22f emitting light. The steps S1 and S2 can also be carried out in reverse order or simultaneously. The display LEDs 22a-22f and the signalling LEDs 25a-25c can be additionally or alternatively controlled via the IO-link connection without the control device 62 controlling the stack light 12.

In an optional step S3, the terminal device 64 is controlled simultaneously in a time-synchronised manner by the control device, such that the warning signal (here as a tone) is emitted to the operator or worker. The steps S2 and S3 run simultaneously.

What is Clamed is:

1. A display device having a housing in which at least one display LED for displaying light information and at least one signalling LED provided in addition to the at least one display LED for signalling a warning state are arranged, wherein a brightness of the at least one signalling LED is greater than a brightness of the at least one display LED, wherein the at least one display LED and the at least one signalling LED can be controlled separately from each other.

2. The display device according to claim 1, wherein the at least one signalling LED is arranged adjacent to a housing wall of the display device, wherein an emission surface of the at least one signalling LED is directed in the direction outwards from the housing.

3. The display device according to claim 1, wherein the at least one signalling LED is arranged on a carrier extending substantially in parallel to the axial axis of the housing.

4. The display device according to claim 1, wherein the at least one signalling LED is arranged adjacent to a housing wall of the display device , wherein an emission surface of the signalling LED points towards a connection socket of the housing , wherein a light coupling element is arranged adjacent to the signalling LED , wherein the light coupling element is set up to deflect light emitted from the signalling LED towards the connection socket in such a way that the light can be directed out of the housing substantially in parallel to the emission surface.

5. The display device according to claim 1, wherein a signalling LED of a plurality of signalling LEDs is arranged in each case in a cross-section of the housing in each corner.

6. The display device according to claim 1, wherein first light guides of the display device run outwards from a common centre point inside the housing , wherein in each case a signalling LED of a plurality of signalling LEDs for signalling the warning state is arranged adjacent to the centre point between each two adjacent first light guides of the first light guides.

7. The display device according to claim 6, wherein an emission surface of the respective signalling LED points in the direction of the common centre point of the first light guides, such that light emitted from the signalling LEDs can be guided out of the housing via the centre point in the first light guides.

8. The display device according to claim 1, wherein the housing has a recess in the region of the light emission of the light that can be emitted into the surroundings by the at least one signalling LED.

9. The display device according to claim 1, wherein the display device further has a light distribution element which is arranged adjacent to the housing wall and is set up to distribute light that can be generated by the at least one display LED and/or the at least one signalling LED in the direction of the housing wall.

10. The display device according to claim 9, wherein the light distribution element is a light distribution film that is set up to guide the light that can be generated by the at least one display LED and/or the at least one signalling LED in a plane shape to the housing wall.

11. The display device according to claim 1, wherein the display device is formed as a stack light , wherein the at least one signalling LED is arranged in an assembled state of the stack light in a cap of the housing of the stack light , which is opposite a connection socket of the stack light , wherein the at least one display LED is arranged between the connection socket and the cap.

12. The display device according to claim 8, wherein the recess is arranged in the region of a part of an edge of the cap and is open towards the connection socket.

13. The display device according to claim 8, wherein the recess is arranged in the region of an edge of the cap on the side of the cap facing away from the connection socket.

14. The display device according to one of claim 1, wherein the display device is formed as an indicator , wherein the at least one signalling LED is arranged in an assembled state of the indicator in a connection socket of the indicator which is opposite a cap and wherein the at least one display LED is arranged under the cap.

15. The display device according to claim 8, wherein the recess is arranged as an opening in the region of a part of an edge of the connection socket.

16. The display device according to claim 1, wherein the at least one signalling LED is set up to emit a brightness according to risk group RG0.

17. The display device according to claim 1, wherein the at least one signalling LED has a fixed colour which is not adjustable and/or wherein the at least one display LED is formed as an RGB LED, and a colour of the at least one display LED is adjustable.

18. The display device according to claim 1, wherein a brightness of the at least one signalling LED , measured in lumens, is at least twice, preferably at least three times, further preferably at least four times, further preferably at least ten times, as a brightness of the at least one display LED.

19. A system, having a display device according to claim 1, a wirelessly connectable control device and a portable wireless terminal device which is set up to emit a warning message synchronised with a flashing and/or blinking of at least one signalling LED.

20. The system according to claim 19, wherein the warning message is visual, haptic and/or acoustic.

21. A method for operating a display device which has a housing in which at least one display LED for displaying light information and at least one signalling LED provided in addition to the at least one display LED for signalling a warning state, are arranged, having the steps:
displaying light information by means of the at least one display LED,
signalling the warning state by means of flashing and/or blinking of at least one signalling LED,
wherein a brightness of the at least one signalling LED is greater than a brightness of the at least one indicator LED, wherein the at least one display LED and the at least one signalling LED are controlled separately from each other.

22. A method according to claim 21, further having:
time-synchronised transmitting a warning message by means of a portable wireless terminal device and signalling the warning state by means of flashing and/or blinking of the at least one signalling LED.
